(19) United States
(12) Patent Application Publication
(10) Pub. No.: US 2015/0324878 A1
(43) Pub. Date: Nov. 12, 2015

(54) ONLINE GROUP SHOPPING SYSTEM AND METHOD

(71) Applicant: DARRYL WAYNE SHORTER, CHARLOTTE, NC (US)

(72) Inventor: DARRYL WAYNE SHORTER, CHARLOTTE, NC (US)

(21) Appl. No.: 14/706,424

(22) Filed: May 7, 2015

Related U.S. Application Data
(60) Provisional application No. 61/990,083, filed on May 7, 2014.

(51) Int. Cl. G06Q 30/06

(52) U.S. Cl. CPC G06Q 30/0605; G06Q 30/0633; G06Q 30/0643

(57) ABSTRACT

A method for allowing multiple users to collaboratively review and select items from one or more retailer servers, including receiving an indication to open a group shop from a first user with a second user at a shopping server, signaling to a second user that a first user has requested the shopping server to open the group shop, at the shopping server, opening the group shop between the first user and the second user, issuing a shop window user interface to the first user that includes a plurality of links to one or more retailer servers, and opening direct communication between the first user and the second user such that the first user's shop window UI is issued to a second user's shop window UI.

### COPYRIGHT STATEMENT

All of the material in this patent document is subject to copyright protection under the copyright laws of the United States and other countries. The copyright owner has no objection to the facsimile reproduction by anyone of the patent document or the patent disclosure, as it appears in official governmental records but, otherwise, all other copyright rights whatsoever are reserved.

### BACKGROUND OF THE INVENTION

The present invention relates to shopping. More specifically, the present invention relates to shopping online.

Shopping online has become a large part of retail sales across the world. The ability to shop at any store whenever and wherever a consumer is located is advantageous for retailer and consumers. 24 hour access to goods and services. This is the benefit of the internet. Websites such as Amazon.com, Fanatics.com, Dicks.com, Walmart.com, etc. are examples of retailer websites that provide the consumer access to what the retailer has available at all times.

Shopping online though is different than shopping in an actual store. Online consumers can't get the opinion of an item from a friend or family prior to purchasing the time. One of the reasons consumer enjoy shopping at shopping malls is the ability to shop with friends/family. Allowing a friend to give his/her opinion on an item prior to purchasing the item can be priceless. Not only does it make it easier for consumer to purchase an item when a friend give s the okay, the retailer benefits by getting a sale and potentially getting a second sale from the friend.

When a consumer is shopping online there is currently no way for the consumer to shop with his/her friend, no way for the consumer to get the needed opinion that would solidify the sale, unless the friend is in the same room looking at the consumer's device. Another wan that a consumer is able to get an opinion from his/her friend is by sending the friend a picture of the item, or a hyperlink to the item via an email, text, message on social media, etc. The friend must then review the item sent to him/her and send a response, including the opinion, to the consumer via email, text, telephone call, etc. Once the consumer gets the opinion of the friend, the consumer then has to decide whether to actually purchase the item.

The problem with this method is that the consumer, by the time the opinion is received, may no longer be in the mood to purchase the item, may have decided not to buy the item, or decided to purchase the item from another retailer or at another time. As a result, the retailer may lose out on the sale.

Also, when friends shop together, there is an opportunity for the retailer to get a sale from each of the friends. For example, when two or more friends are looking at an item to purchase for a child, the friends may each decide to purchase the item as well for his/her respective child, resulting in the retailer receiving two sales instead of one.

Therefore, there exists a need for an improved method and system for shopping online. This and other needs are addressed by one or more aspects of the present invention.

### SUMMARY OF THE INVENTION

The present invention includes many aspects and features. Moreover, while many aspects and features relate to, and are described in, the context of healthcare applications, the present invention is not limited to use only in this context, as will become apparent from the following summaries and detailed descriptions of aspects, features, and one or more embodiments of the present invention.

Accordingly, one aspect of the present invention relates to a method for allowing multiple users to collaboratively review and select items from one or more retailer servers, including receiving an indication to open a group shop from a first user with a second user at a shopping server, signaling to a second user that a first user has requested the shopping server to open the group shop, at the shopping server, opening the group shop between the first user and the second user, issuing a shop window user interface to the first user that includes a plurality of links to one or more retailer servers, and opening direct communication between the first user and the second user such that the first user's shop window UI is issued to a second user's shop window UI.

In addition to the aforementioned aspects and features of the present invention, it should be noted that the present invention further encompasses the various possible combinations and subcombinations of such aspects and features. Thus, for example, any aspect may be combined with an aforementioned feature in accordance with the present invention without requiring any other aspect or feature.

### BRIEF DESCRIPTION OF THE DRAWINGS

One or more preferred embodiments of the present invention now will be described in detail with reference to the accompanying drawings, wherein the same elements are referred to with the same reference numerals, and wherein,

FIG. 1 is an example system illustration of a block diagram of an implementation of a disclosed group shopping system in accordance with the present invention;

FIG. 2 is an example block diagram of a suitable computing device operable in accordance with an implementation of the present invention; and

FIG. 3 is an example screen shot of user's screen in accordance with an implementation of the present invention.

### DETAILED DESCRIPTION

Referring now to the drawings, one or more preferred embodiments of the present invention are next described. The following description of one or more preferred embodiments is merely exemplary in nature and is in no way intended to limit the invention, its implementations, or uses.

As a preliminary matter, it will readily be understood by one having ordinary skill in the relevant art (“Ordinary Artisan”) that the present invention has broad utility and application. As should be understood, any embodiment may incorporate only one or a plurality of the above-disclosed aspects of the invention and may further incorporate only one or a plurality of the above-disclosed features. Furthermore, any embodiment discussed and identified as being “preferred” is considered to be part of a best mode contemplated for carrying out the present invention. Other embodiments also may be discussed for additional illustrative purposes in providing a full and enabling disclosure of the present invention. As should be understood, any embodiment may incorporate only one or a plurality of the above-disclosed aspects of the invention and may further incorporate only one or a plurality of the above-disclosed features. Moreover, many embodiments, such as adaptations, variations, modifications, and equivalent arrangements, will be implicitly disclosed by the embodiments described herein and fall within the scope of the present invention.

Accordingly, while the present invention is described herein in detail in relation to one or more embodiments, it is to be understood that this disclosure is illustrative and exemplary of the present invention, and is made merely for the purposes of providing a full and enabling disclosure of the present invention. The detailed disclosure herein of one or more embodiments is not intended, nor is to be construed, to limit the scope of patent protection afforded the present invention, which scope is to be defined by the claims and the equivalents thereof. It is not intended that the scope of patent protection afforded the present invention be defined by reading into any claim a limitation found herein that does not explicitly appear in the claim itself

Thus, for example, any sequence(s) and/or temporal order of steps of various processes or methods that are described herein are illustrative and not restrictive. Accordingly, it should be understood that, although steps of various processes or methods may be shown and described as being in a sequence or temporal order, the steps of any such processes or methods are not limited to being carried out in any particular sequence or order, absent an indication otherwise. Indeed, the steps in such processes or methods generally may be carried out in various different sequences and orders while still falling within the scope of the present invention. Accordingly, it is intended that the scope of patent protection afforded the present invention is to be defined by the appended claims rather than the description set forth herein.

Additionally, it is important to note that each term used herein refers to that which the Ordinary Artisan would understand such term to mean based on the contextual use of such term herein. To the extent that the meaning of a term used herein—as understood by the Ordinary Artisan based on the contextual use of such term—differs in any way from any particular dictionary definition of such term, it is intended that the meaning of the term as understood by the Ordinary Artisan should prevail.

Systems, methods, and computer-readable media for providing multiple users with the ability to shop online with each other using an electronic device are provided and described with reference to the FIGS. According to certain embodiments, a system is designed that allows a user to shop online using a computing device with friends (i.e., other users) using a separate computing device. The user can log on to a shopping website that is provided to the user through the internet, wherein a shopping server processor renders a shopping user interface. The user may invite a friend to shop with the user by requesting the friend to join the user's shopping trip. The shopping server initiates a connection between the user and the invited friend that allows the friend to participate real-time with the user in shopping. This method and system allows the user and friend to experience a virtual shopping trip together giving them real-time access to each other's opinions and companionship.

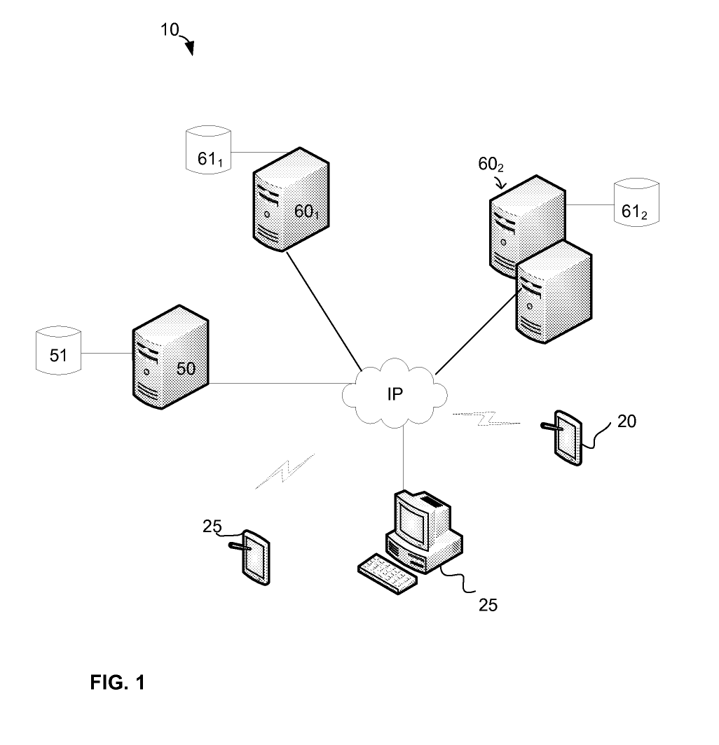

An example diagram of a disclosed implementation of the shopping system is illustrated in FIG. 1. The shopping system 10 includes a shopping app server 50, one or more retailer servers 60, and one or more mobile computing devices 20, 25. The shopping app server 50 includes one or more processors and one or more non-transitory computer-readable mediums, for example, memory. The one or more of the one or more computer-readable mediums include one or more computer programs.

An implementation of the disclosed system and method for providing a plurality of users to shop online together. First and second users log into the shopping server. The first user using a first computing device initiates a group shop with the second user, the second user using a second computing device separate from the computing device used by the first user. The processor forwards a request shop signal to the computing device of the second user. The second app server receives the response from the second user.

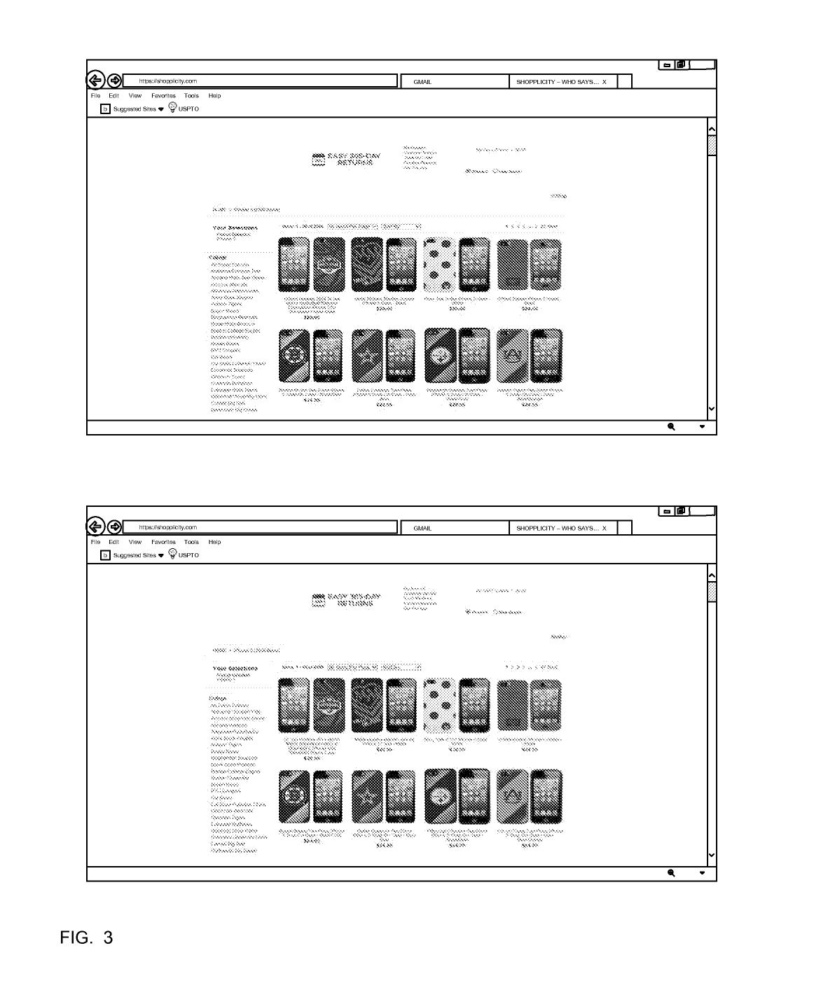

If the second user accepts the invitation to group shop, the shopping app processor initiates a group shop user interface (UI) in the displays of each of the first and second computing devices. The group shop UI may be a window that is displayed for each user simultaneously, wherein the group shop UI displayed to each user is changed simultaneously for each user, such that when the first user selects an item or moves within the group UI, the second user sees the exactly what is being displayed to the first user, and vice versa. See FIG. 3.

In another implementation, the shop app processor initiates the sharing of the first user's desktop with the second user. Preferably, the user that initiates the group shop is the window that is shared by the group shop app.

Once the group shop UI is initiated by the shop app processor, the first and second users may begin to shop. In an implementation of the group shop app, a list of participating retailers are displayed over the group shop UI. The participating retailers are those retailers that have elected to be a part of the group shop experience. The retailers provide the shop app server with a link to the retailer's server that operates the retailer's e-commerce website (online store). Accordingly, participating retailers may be those retailers that have an e-commerce website that allows a consumer to purchase items from the retailer's online store.

Accordingly, the list provide to the group shop UI are those retailers that, when selected by the first or second user, will provide the shopping server with access to its online store. one of the first or second users may then select one of the participating retailers from the list of retailers. When a retailer is selected, the shopping app processor detects the selection of the retailer and initiates a connection to the retailer's online store. Once the connection has been made with the online store, the shopping app processor displays the retailer's online store to each of the group shop UIs displayed on the first and second user's computing devices. When one the first or second users select an item in the online store, each group shop UI displays the item as if the user's are viewing the same screen.

In a preferred implementation, a chat window may be initiated within the group shop UI that allows the first and second users to communication with each other while shopping. The chat window may be a video chat window and/or a text chat window. Therefore when the first or second user selects an item from the retailer's online store displayed in the group shop UI, the first and second user can discuss the item as it is being viewed. This allows the first and/or second user to get the feedback of the other to assist in determining whether to purchase the item.

During the group shop, either the first or second user may select an item or select another retailer, etc. When one of the first or second users makes a selection the shop app processor changes each group shop UI in accordance with the selection.

When the first or second user wishes to purchase an item, the respective user places the item in his/her shopping cart. The shopping cart of the first and second user is stored and operated on the shopping app server, not the retailer's website. When the user checks out and pays for all items in the shopping cart, the shopping app server deducts an admin fee from the purchase from each purchase. The shopping app server pays each of the retailers from which a purchase was made in accordance with the agreement with the retailer. For example, the shopping app server owner, i.e., Shopplicity, would keep 5% of all transactions made through its shopping server. The shopping app server owner would also collect and pay any taxes that are due based on the transaction.

In an implementation, when a user is ready to checkout, the group shop processor deactivates the group shop such that the group shop UIs for the first and second user are no longer the same, or the group shop processor disables the desktop sharing between the first and second user. Checkout may take place at the end of the shopping session or at any point during the group shopping session. If checkout is initiated during the group shop session, the session is only temporarily disconnected to allow the respective user's to keep their respective information private. Once the checkout has been completed by the first and/or second user, the user checking out is asked if the group shop session should be connected again.

The ability to shop with multiple users simultaneously is also very useful for purchasing airline tickets, hotels, vacations stays, golf outings, etc. Each user is able to purchase any item through the shop application server with a friend.

In another implementation, an software application is downloaded on a user's computing device and stored on a computer readable medium for execution by the user. When the user selects the application, a processor executes the software application. A user interface is displayed to the user on the computing device display to the user. The user interface

In another implementation of the disclosed system and method, a first user is able to place items for purchase in a second user's shopping cart even when the second user is not online. For example, the first user finds one or more items that the first user believes the second user would purchase or would likely purchase. The first user then signals to the shopping application server a request to add items to a second user's shopping cart. Based on the permissions allowed for the first user by the second user, the shopping application server will allow the first user to place items in the second user's shopping cart. The first user then places those items the first user has selected into the second user's shopping cart. Once the first user has completed the selection of all items to be placed in the second user's shopping cart, the shopping application server stores the second user's shopping cart for access by the second user when the second user logs in. When the second user logs in, the shopping application server indicates to the second user that the first user has placed one or more items in the second user's shopping cart for purchase by the second user. The second user may then accept or reject each item, or all items, placed in the shopping cart by the first user. Those items that the second user accepts are kept in the second user's shopping cart for check out when the second user is ready.

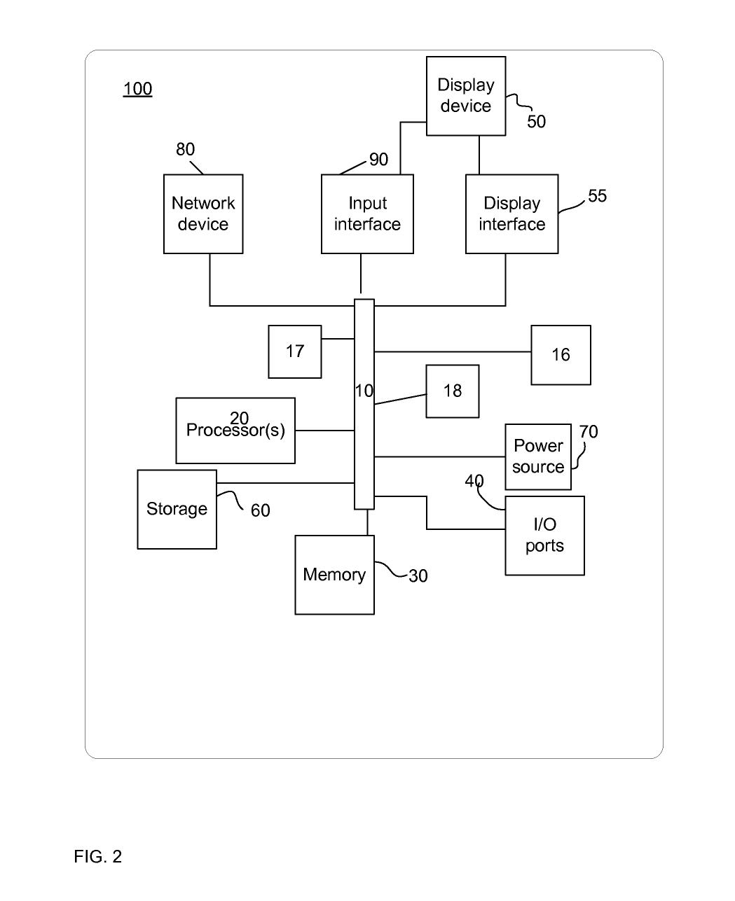

An example of a suitable computing device operable in accordance with an implementation of the disclosed system and method is illustrated in FIG. 2. It should be noted that the various functional blocks shown in FIG. 2 may include hardware elements, software elements (including computer code or instructions stored on a non-transitory machine-readable medium) or a combination of both hardware and software elements. The computing device 100, may be implemented in different forms. For example, the computing device 100 may be implemented as a server, group of servers, a desktop computer, laptop, workstation, personal digital assistant (PDA) and other appropriate computers. The computing device 100 includes a bus 10, display interface 55, display device 50, I/O ports 40, Input interface 90, data processing circuitry, such as one or more processors 20, a memory device 30, a non-volatile storage 60, a networking device 80 and a power source 70.

The computing device may also be implemented as a mobile computing device. The mobile computing device may be implemented by various mobile devices, such as PDAs, cellular phones, smart phones, tablets and other similar computing devices. The mobile computing device includes a bus, a display, I/O ports, Input displays, one or more processors, a memory device, a non-volatile storage, a networking device, a power source, and a transceiver for implementing wireless communication under various protocols, such as SMS or MMS messaging, CDMA, TDMA, WCDMA or GPRS, among others. The components of the computing devices as shown, their connections and relationships and their functions are meant for exemplary purposes only, and are not meant to limit implementations of the disclosed inventions described and/or claimed in this disclosure.

The display device 50 may be used to display images generated by the computing device 100, for example a graphical user interface (GUI). The display 50 may be any type of display such as a cathode ray tube (CRT), a liquid crystal display (LCD), a light emitting diode (LED) display, or other suitable display. In certain implementations of the computing device 100, the display 50 may include a touch-sensitive element, such as a touch screen.

The processor(s) 20 may provide data processing capability to execute and support one or more operating systems, computer programs, user and application interfaces, software systems and applications, and any other functions of the computing device 100 that may be stored in the memory device 30 or on the storage device 60. The processor(s) 20 may include one or more microprocessors, such as one or more “general-purpose” microprocessors, one or more special-purpose microprocessors and/or ASICS, for example.

The processor(s) 20 may communicate with a user through input interface 90 and display interface 55 coupled to the display 50. The display interface 55 may comprise appropriate circuitry for driving the display 50 to present graphical and other information to a user. The input interface 90 may receive commands from a user and convert them for submission to the processor 20.

The instructions or data to be processed by the processor(s) 20 may be stored in a memory 30. The memory 30 may be provided as a volatile memory, such as random access memory (RAM), and/or as a non-volatile memory, such as read-only memory (ROM). The memory 30 may store a variety of information and may be used for various purposes. For example, the memory 30 may store firmware executed by a processor 20 (such as methods and systems that enable at least a first and second users remote from each other to shop simultaneously on line together as discussed herein), other programs that enable various functions of the computing device 100, user interface functions, processor functions. The memory 30 may also be another form of computer-readable medium.

The components may further include a non-volatile storage 22 for persistent storage of data and/or instructions. The non-volatile storage 22 may include flash memory, a hard drive, or any other optical, magnetic, and/or solid-state storage media. The non-volatile storage 22 may be used to store data files, software, wireless connection information (e.g., information that may enable the electronic device 10 to establish a wireless connection, and any other suitable data. In addition, the non-volatile storage 60 may also store code and/or data for implementing various functions of the electronic device 100, such as application or program code, data associated with such applications or programs, operating system code, user configured preferences, as well as code for implementing methods and systems that enable at least a first and second users remote from each other to shop simultaneously on line together as discussed herein. In implementation, the storage device 60 may be or contain a computer-readable medium. A computer program product can be tangibly embodied in an information carrier. The computer program products may also contain instructions that, when executed, perform one or more methods, such as those described above. The information carrier is a computer- or machine-readable medium, such as the memory 30, the storage device 60, memory on processor 20, or a propagated signal.

A machine-readable medium includes any mechanism for storing or transmitting information in a form readable by a machine (e.g., a computer). For example, a machine-readable medium includes read only memory (“ROM”); random access memory (“RAM”); magnetic disk storage media; optical storage media; flash memory devices; electrical, optical, acoustical or other form of propagated signals (e.g., carrier waves, infrared signals, digital signals, etc.); etc.

The disclosed system and methods are preferably implemented by software, hardware, or a combination of hardware and software. The disclosed implementations can include implementation in one or more computer programs that are executable and/or interpretable on a programmable processor, which may be special or general purpose, coupled to receive data and instructions from, and to transmit data and instructions to, a storage system, at least one input device, and at least one output device.

These computer programs (also known as programs, software, software applications or code) include machine instructions for a programmable processor, and can be implemented in an appropriate programming language. As used herein, the terms “machine-readable medium” “computer-readable medium” refers to any computer program product, apparatus and/or device (e.g., magnetic discs, optical disks, memory) used to provide machine instruction and/or data to a programmable processor. The computer readable medium can also be distributed over network-coupled computer systems so that the computer readable code is stored and executed in a distributed fashion.

Based on the foregoing description, it will be readily understood by those persons skilled in the art that the present invention is susceptible of broad utility and application. Many embodiments and adaptations of the present invention other than those specifically described herein, as well as many variations, modifications, and equivalent arrangements, will be apparent from or reasonably suggested by the present invention and the foregoing descriptions thereof, without departing from the substance or scope of the present invention. Accordingly, while the present invention has been described herein in detail in relation to one or more preferred embodiments, it is to be understood that this disclosure is only illustrative and exemplary of the present invention and is made merely for the purpose of providing a full and enabling disclosure of the invention. The foregoing disclosure is not intended to be construed to limit the present invention or otherwise exclude any such other embodiments, adaptations, variations, modifications or equivalent arrangements, the present invention being limited only by the claims appended hereto and the equivalents thereof

What is claimed is:

1. A method comprising:
receiving an indication to open a group shop from a first user with a second user at a shopping server;
signaling to a second user that a first user has requested the shopping server to open the group shop;
at the shopping server, opening the group shop between the first user and the second user;
issuing a shop window user interface to the first user that includes a plurality of links to one or more retailer servers; and
opening direct communication between the first user and the second user such that the first user's shop window UI is issued to a second user's shop window UI.

2. The method of claim 1, further comprising:
detecting the selection of a retailer server at the shopping server;
connecting to the selected retailer server by the shopping server; and
issuing, by the shopping server, a retailer UI over the first user and second user shop window UI to allow the first user and the second user to select items available through the retailer server.

3. The method of claim 2, further comprising:
detecting a selection of an item from the retailer by at least one of the first user and the second user; and
placing the selected item in a shopping cart of the at least one of the first user and the second user that selected the item, wherein the shopping cart is stored in memory.

4. The method of claim 3, further comprising:
detecting a checkout indication, at the shopping server, from at least one of the first user and second user;
disabling the direct connection between the first user shop window and the second user, such the second user shop window UI is issued separately by the shopping server; and
issuing a checkout UI to the user that has indicated to the shopping server to checkout.

5. The method of claim 2, wherein the first user and second user simultaneously interact with the shopping server through the first user shop window UI.

6. The method of claim 5, wherein the first user is remote to the second user.

7. The method of claim 6 further comprising:
issuing a communication window in the first user and the second user shop window UIs wherein the first user and the second user communicated real time with one another.

8. The method of claim 7, wherein the real time communication is via instant messaging.

9. The method of claim 8, wherein the real time communication is via video chat.

10. A system comprising:
one or more processors; and
a non-transitory computer-readable medium storing a computer program for operating a method for allowing multiple users to collaboratively review and select items from one or more retailer servers, the computer program executed by the one or more processors, the computer program comprising instructions for:
receiving an indication to open a group shop from a first user with a second user at a shopping server;
signaling to a second user that a first user has requested the shopping server to open the group shop;
at the shopping server, opening the group shop between the first user and the second user;
issuing a shop window user interface to the first user that includes a plurality of links to one or more retailer servers; and
opening direct communication between the first user and the second user such that the first user's shop window UI is issued to a second user's shop window UI.

11. The system of claim 10, wherein the computer program further comprises:
detecting the selection of a retailer server at the shopping server;
connecting to the selected retailer server by the shopping server; and
issuing, by the shopping server, a retailer UI over the first user and second user shop window UI to allow the first user and the second user to select items available through the retailer server.

12. The system of claim 11, wherein the computer program further comprises:
detecting a selection of an item from the retailer by at least one of the first user and the second user; and
placing the selected item in a shopping cart of the at least one of the first user and the second user that selected the item, wherein the shopping cart is stored in memory.

13. The system of claim 12, wherein the computer program further comprises:
detecting a checkout indication, at the shopping server, from at least one of the first user and second user;
disabling the direct connection between the first user shop window and the second user, such the second user shop window UI is issued separately by the shopping server; and
issuing a checkout UI to the user that has indicated to the shopping server to checkout.

14. The system of claim 11, wherein the first user and second user simultaneously interact with the shopping server through the first user shop window UI.

15. The system of claim 14, wherein the first user is remote to the second user.

16. The system of claim 15, wherein the computer program further comprises:
issuing a communication window in the first user and the second user shop window UIs wherein the first user and the second user communicated real time with one another.

17. The system of claim 16, wherein the real time communication is via instant messaging.

18. The system of claim 17, wherein the real time communication is via video chat.
